(19) United States
(12) Patent Application Publication
(10) Pub. No.: US 2026/0304467 A1
(43) Pub. Date: Oct. 1, 2026

(54) PERFORMANCE MONITORING FOR ARTIFICIAL INTELLIGENCE OR MACHINE LEARNING BASED RADIO RESOURCE MANAGEMENT PREDICTION

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US)

(21) Appl. No.: 19/578,609

(22) Filed: Mar. 25, 2026

Related U.S. Application Data
(60) Provisional application No. 63/779,101, filed on Mar. 27, 2025.

(51) Int. Cl. H04W 72/542; H04L 41/16; H04W 24/10

(52) U.S. Cl. CPC H04W 72/542; H04L 41/16; H04W 24/10

(57) ABSTRACT

Certain aspects of the present disclosure provide techniques for receiving a measurement configuration comprising one or more measurement object indications, the one or more measurement object indications indicating a first measurement object associated with radio resource management (RRM) prediction and a second measurement object associated with performance monitoring for the RRM prediction; transmitting a first report, based on the first measurement object, of a first result of the RRM prediction; and transmitting a second report, based on the second measurement object, of a second result of the performance monitoring, wherein the second report includes or is associated with an indication of the first measurement object associated with the RRM prediction.

### CROSS-REFERENCE TO RELATED APPLICATION(S)

The present Application for Patent claims benefit of U.S. Provisional Application No. 63/779,101, filed Mar. 27, 2025, which is hereby expressly incorporated by reference herein in its entirety.

### INTRODUCTION

### Field of the Disclosure

Aspects of the present disclosure relate to wireless communications, and more particularly, to techniques for performance monitoring for artificial intelligence or machine learning based radio resource management prediction.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Some aspects provides a method for wireless communications by an apparatus. The method includes receiving a measurement configuration comprising one or more measurement object indications, the one or more measurement object indications indicating a first measurement object associated with radio resource management (RRM) prediction and a second measurement object associated with performance monitoring for the RRM prediction; transmitting a first report, based on the first measurement object, of a first result of the RRM prediction; and transmitting a second report, based on the second measurement object, of a second result of the performance monitoring, wherein the second report includes or is associated with an indication of the first measurement object associated with the RRM prediction.

Some aspects provide one or more apparatuses configured for wireless communications. The one or more apparatuses include one or more memories and one or more processors, coupled to the one or more memories, configured to cause the one or more apparatuses to: receive a measurement configuration comprising one or more measurement object indications, the one or more measurement object indications indicating a first measurement object associated with RRM prediction and a second measurement object associated with performance monitoring for the RRM prediction; transmit a first report, based on the first measurement object, of a first result of the RRM prediction; and transmit a second report, based on the second measurement object, of a second result of the performance monitoring, wherein the second report includes or is associated with an indication of the first measurement object associated with the RRM prediction.

Some aspects provide one or more apparatuses configured for wireless communications. The one or more apparatuses include: means for receiving a measurement configuration comprising one or more measurement object indications, the one or more measurement object indications indicating a first measurement object associated with RRM prediction and a second measurement object associated with performance monitoring for the RRM prediction; means for transmitting a first report, based on the first measurement object, of a first result of the RRM prediction; and means for transmitting a second report, based on the second measurement object, of a second result of the performance monitoring, wherein the second report includes or is associated with an indication of the first measurement object associated with the RRM prediction.

Another aspect provides one or more non-transitory computer-readable media. The one or more non-transitory computer-readable media include executable instructions that, when executed by one or more processors of one or more apparatuses, cause the one or more apparatuses to: receive a measurement configuration comprising one or more measurement object indications, the one or more measurement object indications indicating a first measurement object associated with RRM prediction and a second measurement object associated with performance monitoring for the RRM prediction; transmit a first report, based on the first measurement object, of a first result of the RRM prediction; and transmit a second report, based on the second measurement object, of a second result of the performance monitoring, wherein the second report includes or is associated with an indication of the first measurement object associated with the RRM prediction.

In some examples of the methods, apparatuses, and non-transitory computer-readable medium described herein, the first measurement object and the second measurement object are a same measurement object.

In some examples of the methods, apparatuses, and non-transitory computer-readable medium described herein, the first report is based on a first reporting configuration containing a report configuration identifier for the RRM prediction and the second report is based on a second reporting configuration containing a report configuration identifier for the performance monitoring.

In some examples of the methods, apparatuses, and non-transitory computer-readable medium described herein, the indication of the first measurement object is a measurement identity that indicates the first measurement object.

In some examples of the methods, apparatuses, and non-transitory computer-readable medium described herein, the measurement identity further indicates a report configuration identifier for the RRM prediction.

In some examples of the methods, apparatuses, and non-transitory computer-readable medium described herein, the same measurement object is used for configuring measurement objects for both RRM prediction and performance monitoring.

In some examples of the methods, apparatuses, and non-transitory computer-readable medium described herein, the same measurement object is configured for reporting the first result based on a first report configuration identifier for the RRM prediction and for reporting a measurement result based on a second report configuration identifier for the performance monitoring.

In some examples of the methods, apparatuses, and non-transitory computer-readable medium described herein, the indication of the first measurement object comprises the first report, wherein the first report is sent with the second report.

In some examples of the methods, apparatuses, and non-transitory computer-readable medium described herein, the first measurement object is different than the second measurement object.

In some examples of the methods, apparatuses, and non-transitory computer-readable medium described herein, the indication of the first measurement object is a measurement identity that indicates the first measurement object.

In some examples of the methods, apparatuses, and non-transitory computer-readable medium described herein, the one or more measurement object indications include a first measurement object indication that indicates the first measurement object and a second measurement object indication that indicates the second measurement object.

In some examples of the methods, apparatuses, and non-transitory computer-readable medium described herein, the second measurement object indication further indicates a first report configuration for the first report and a second report configuration for the second report.

In some examples of the methods, apparatuses, and non-transitory computer-readable medium described herein, the first report and the second report are included in a single report.

In some examples of the methods, apparatuses, and non-transitory computer-readable medium described herein, the single report includes a first indication of the first measurement object or a second indication of the second measurement object.

In some examples of the methods, apparatuses, and non-transitory computer-readable medium described herein, the single report includes a first portion for the first result and a second portion for the second result.

In some examples of the methods, apparatuses, and non-transitory computer-readable medium described herein, transmitting the second report comprises transmitting the second report at each of a set of configured monitoring occasions.

In some examples of the methods, apparatuses, and non-transitory computer-readable medium described herein, transmitting the second report comprises transmitting the second report based on a monitoring window, wherein the second result is based on a set of monitoring occasions in the monitoring window.

Some examples of the methods, apparatuses, and non-transitory computer-readable medium described herein may further include operations, features, means, or instructions for combining a set of indicators that are based on measurements in the set of monitoring occasions to generate the second result.

Some aspects provide a method for wireless communications by an apparatus. The method includes: transmitting a measurement configuration comprising one or more measurement object indications, the one or more measurement object indications indicating a first measurement object associated with RRM prediction and a second measurement object associated with performance monitoring for the RRM prediction; receiving a first report, based on the first measurement object, of a first result of the RRM prediction; and receiving a second report, based on the second measurement object, of a second result of the performance monitoring, wherein the second report includes or is associated with an indication of the first measurement object associated with the RRM prediction.

Some aspects provide one or more apparatuses configured for wireless communications. The one or more apparatuses include one or more memories and one or more processors, coupled to the one or more memories, configured to cause the one or more apparatuses to: transmit a measurement configuration comprising one or more measurement object indications, the one or more measurement object indications indicating a first measurement object associated with RRM prediction and a second measurement object associated with performance monitoring for the RRM prediction; receive a first report, based on the first measurement object, of a first result of the RRM prediction; and receive a second report, based on the second measurement object, of a second result of the performance monitoring, wherein the second report includes or is associated with an indication of the first measurement object associated with the RRM prediction.

Some aspects provide one or more apparatuses configured for wireless communications. The one or more apparatuses include: means for transmitting a measurement configuration comprising one or more measurement object indications, the one or more measurement object indications indicating a first measurement object associated with RRM prediction and a second measurement object associated with performance monitoring for the RRM prediction; means for receiving a first report, based on the first measurement object, of a first result of the RRM prediction; and means for receiving a second report, based on the second measurement object, of a second result of the performance monitoring, wherein the second report includes or is associated with an indication of the first measurement object associated with the RRM prediction.

Some aspects provide one or more non-transitory computer-readable media. The one or more non-transitory computer-readable media include executable instructions that, when executed by one or more processors of one or more apparatuses, cause the one or more apparatuses to: transmit a measurement configuration comprising one or more measurement object indications, the one or more measurement object indications indicating a first measurement object associated with RRM prediction and a second measurement object associated with performance monitoring for the RRM prediction; receive a first report, based on the first measurement object, of a first result of the RRM prediction; and receive a second report, based on the second measurement object, of a second result of the performance monitoring, wherein the second report includes or is associated with an indication of the first measurement object associated with the RRM prediction.

In some examples of the methods, apparatuses, and non-transitory computer-readable medium described herein, the first measurement object and the second measurement object are a same measurement object.

In some examples of the methods, apparatuses, and non-transitory computer-readable medium described herein, the first report is based on a first reporting configuration containing a report configuration identifier for the RRM prediction and the second report is based on a second reporting configuration containing a report configuration identifier for the performance monitoring.

In some examples of the methods, apparatuses, and non-transitory computer-readable medium described herein, the indication of the first measurement object is a measurement identity that indicates the first measurement object.

In some examples of the methods, apparatuses, and non-transitory computer-readable medium described herein, the measurement identity further indicates a report configuration identifier for the RRM prediction.

In some examples of the methods, apparatuses, and non-transitory computer-readable medium described herein, the same measurement object is used for configuring measurement objects for both RRM prediction and performance monitoring.

In some examples of the methods, apparatuses, and non-transitory computer-readable medium described herein, the same measurement object is configured for reporting the first result based on a first report configuration identifier for the RRM prediction and for reporting a measurement result based on a second report configuration identifier for the performance monitoring.

In some examples of the methods, apparatuses, and non-transitory computer-readable medium described herein, the indication of the first measurement object comprises the first report, wherein the first report is sent with the second report.

In some examples of the methods, apparatuses, and non-transitory computer-readable medium described herein, the first measurement object is different than the second measurement object.

In some examples of the methods, apparatuses, and non-transitory computer-readable medium described herein, the indication of the first measurement object is a measurement identity that indicates the first measurement object.

In some examples of the methods, apparatuses, and non-transitory computer-readable medium described herein, the one or more measurement object indications include a first measurement object indication that indicates the first measurement object and a second measurement object indication that indicates the second measurement object.

In some examples of the methods, apparatuses, and non-transitory computer-readable medium described herein, the second measurement object indication further indicates a first report configuration for the first report and a second report configuration for the second report.

In some examples of the methods, apparatuses, and non-transitory computer-readable medium described herein, the first report and the second report are included in a single report.

In some examples of the methods, apparatuses, and non-transitory computer-readable medium described herein, the single report includes a first indication of the first measurement object or a second indication of the second measurement object.

In some examples of the methods, apparatuses, and non-transitory computer-readable medium described herein, the single report includes a first portion for the first result and a second portion for the second result.

In some examples of the methods, apparatuses, and non-transitory computer-readable medium described herein, receiving the second report comprises receiving the second report at each of a set of configured monitoring occasions.

In some examples of the methods, apparatuses, and non-transitory computer-readable medium described herein, receiving the second report comprises receiving the second report based on a monitoring window, wherein the second result is based on a set of monitoring occasions in the monitoring window.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram illustrating example beam prediction by a UE.

FIG. 6 is a diagram illustrating an example AI architecture that may be used for AI-enhanced wireless communications.

FIG. 7 illustrates an example AI architecture of a first wireless device that is in communication with a second wireless device.

FIG. 8 is an illustrative block diagram of an example artificial neural network (ANN).

FIG. 9 is a diagram illustrating examples of reference signal sets for radio resource management (RRM) inference and performance monitoring reporting.

FIG. 10 is a diagram illustrating an example of signaling for RRM prediction and performance monitoring reporting.

FIG. 11 is a diagram illustrating another example of signaling for RRM prediction and performance monitoring reporting.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for performance monitoring for artificial intelligence or machine learning based radio resource management prediction. “Radio resource management” (RRM) refers to a set of algorithms and mechanisms that provide for efficient utilization of radio spectrum and network resources. RRM may include functions such as radio resource allocation and scheduling, power control, mobility management, beam management, load balancing, interference coordination and mitigation, cell selection or reselection, or the like.

RRM is based on RRM measurement. “RRM measurement” refers to the collecting and/or analyzing of radio signal parameters to efficiently allocate and manage network resources. These measurements encompass various signal quality indicators including reference signal received power (RSRP), reference signal received quality (RSRQ), and Signal-to-Interference-plus-Noise ratio (SINR). RRM measurements are performed by user equipment (UEs) to maintain network performance under varying conditions and requirements. RRM measurement may be configured via a measurement configuration that indicates measurement objects (which indicate which resources or parameters to measure) and reporting configurations (which indicate how to report these measurements). Examples of RRM measurements, or functions performed using these RRM measurements, include cell-level measurements, beam-level measurements, measurement event detection, radio link failure detection, and handover failure detection.

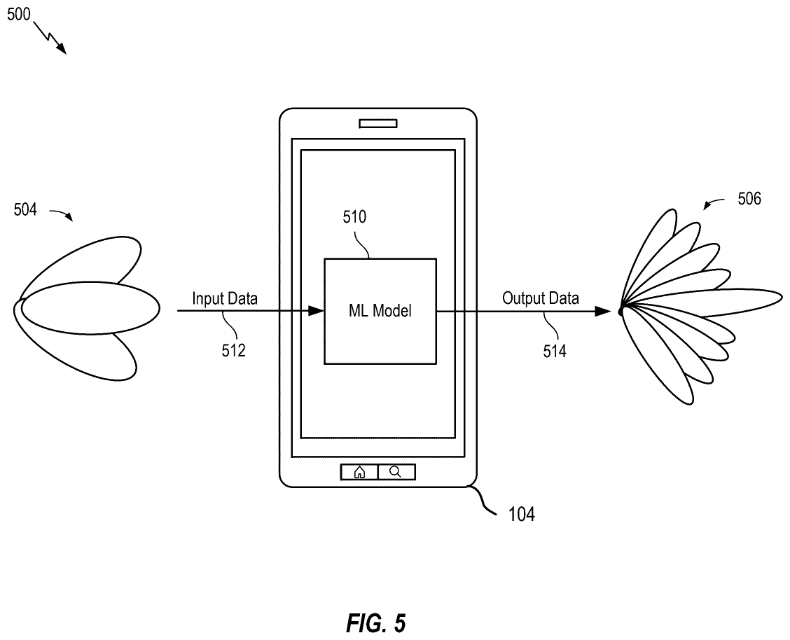

Certain wireless communications systems (e.g., a 5G New Radio (NR) system and/or any future wireless communications system) may employ artificial intelligence (AI) to perform various operations, such as RRM prediction, which may include beam management, UE mobility management, or other RRM-related functions. In certain cases, these operations may be referred to as functions, features, feature groups, use cases, or sub-use cases for AI-aided wireless communications. As an example of certain use case(s) for beam prediction, the UE may use a machine learning (ML) model to determine temporal and/or spatial beam prediction(s) for a set of A-beams based on measurement results of a set of B-beams, as further described herein with respect to FIGS. 5-9. RRM prediction may be used for cell-level measurement prediction, beam-level measurement prediction, measurement event prediction, radio link failure prediction, and handover failure prediction, among other examples.

It may be beneficial to monitor the performance of an ML model used to perform RRM prediction. For example, a UE or network entity may compute one or more monitoring key performance indicators (KPIs) based on comparing actual RRM measurements and RRM predictions associated with the actual RRM measurements. These KPIs can be reported to the network and/or used to update the ML model. In some examples, the resources used to perform performance monitoring and the resources used to perform RRM measurement are the same as one another (e.g., may include the same reference signal resources, cells, beams, or ARFCN(s)). In some other examples, the resources used to perform performance monitoring may be a subset (such as a proper subset) of the resources used to perform RRM measurement. For example, the resources used to perform RRM measurement for beams may include beams (SSB or CSI-RS) A₁ . . . A₉, and the beams (SSB or CSI-RS) used to perform performance monitoring may include beams (SSB or CSI-RS) A₁ . . . A₅.

Technical problems in the domain of RRM prediction and performance monitoring may include complexity in configuration and reporting of RRM measurement, inference, and performance monitoring. For example, a UE may report RRM prediction results, and may also report performance monitoring results that indicate how well an ML model performed in generation of the RRM prediction results. However, without a mechanism for indicating association between the RRM prediction results and the performance monitoring results, it may be unclear which RRM prediction is being monitored, thereby decreasing the effectiveness of the performance monitoring. Furthermore, a same approach may not work for both of (1) a situation where the size of the RRM prediction resource set and the size of the performance monitoring resource set are the same, and (2) a situation where the performance monitoring resource set is a subset of the RRM prediction resource set.

Aspects of the present disclosure relate generally to configuration of RRM measurement, inference, and performance monitoring. Some aspects more specifically relate to configuration of RRM prediction and performance monitoring related to the RRM prediction via one or more measurement configurations. For example, some aspects provide configuration of RRM prediction and performance monitoring in a case where the size of the RRM prediction resource set, and the size of the performance monitoring resource set, are the same as one another. This may involve configuration of a single measurement object that is used for both RRM prediction and performance monitoring. Some other aspects provide configuration of RRM prediction and performance monitoring in a case where the size of the RRM prediction resource set, and the size of the performance monitoring resource set, are different from one another. Here, separate measurement objects may be configured for the RRM prediction and the performance monitoring. Aspects described herein also provide a mapping between (such as information that links) reporting of RRM prediction and reporting of performance monitoring associated with the RRM prediction. For example, this mapping can be provided by jointly reporting measurement identities for the RRM prediction and the performance monitoring, or by jointly reporting measurement values of the RRM prediction and the performance monitoring.

Aspects of the present disclosure may be used to realize one or more of the following possible advantages. By configuring and providing a mapping between RRM prediction and performance monitoring, identification of a subject of the performance monitoring is simplified relative to other approaches such as implicit tracking of the subject, thereby improving performance of performance monitoring. By using a same measurement object for RRM prediction and performance monitoring when the size of the RRM prediction resource set, and the size of the performance monitoring resource set, are the same as one another, overhead is reduced relative to explicitly configuring different measurement objects. By using different measurement objects for RRM prediction and performance monitoring when the size of the RRM prediction resource set, and the size of the performance monitoring resource set, are different from one another, support for differing sizes of resource sets between the RRM prediction and the performance monitoring is improved.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

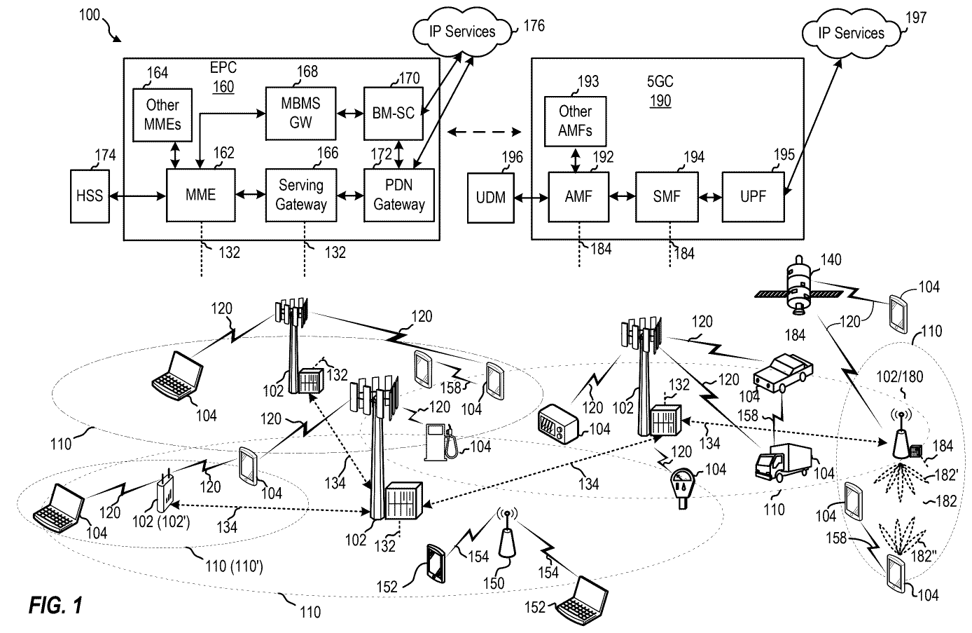

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

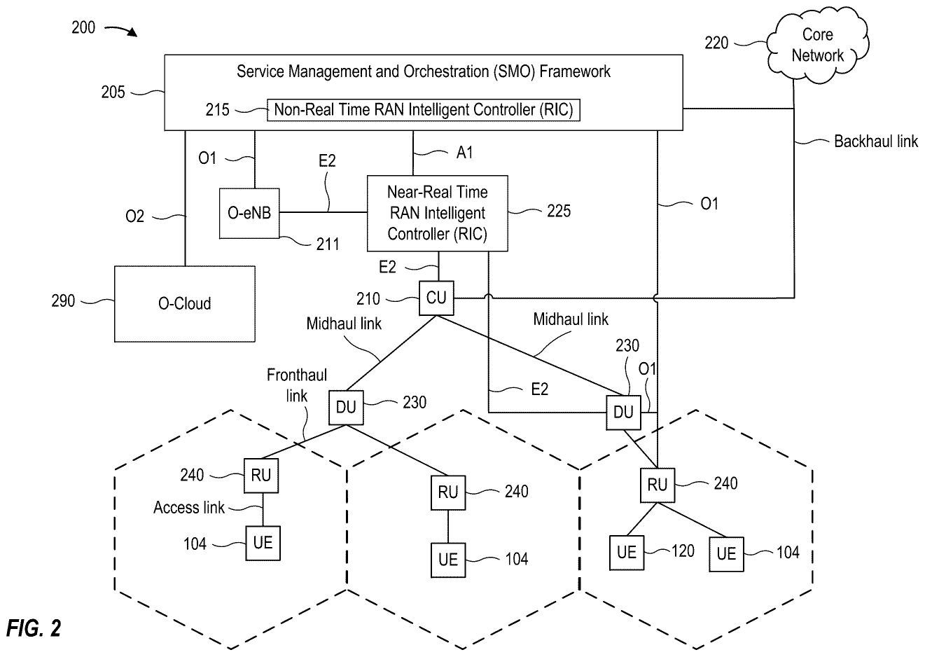

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

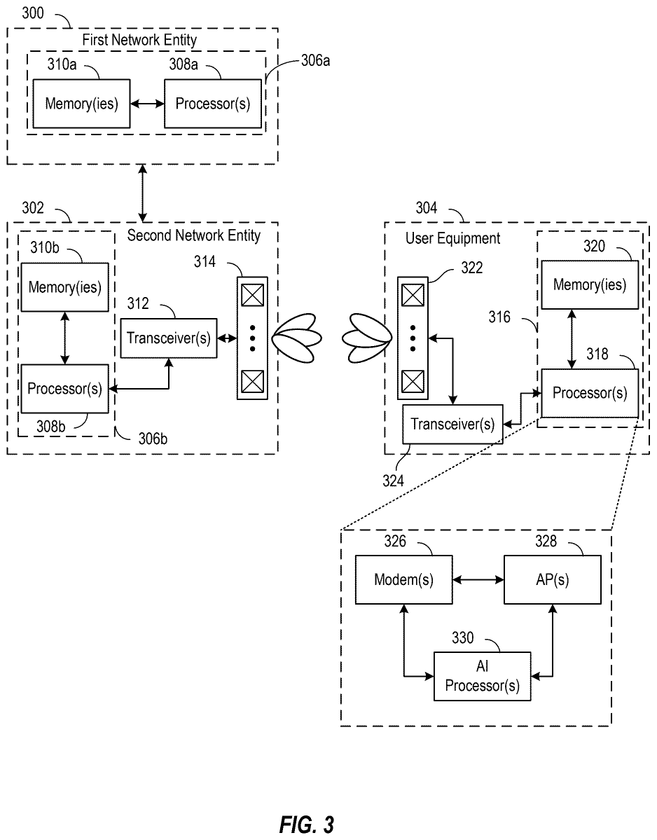

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases , the AI processor may perform certain RAN-based functions including, for example, network planning, network performance management, energy-efficient network operations, etc.

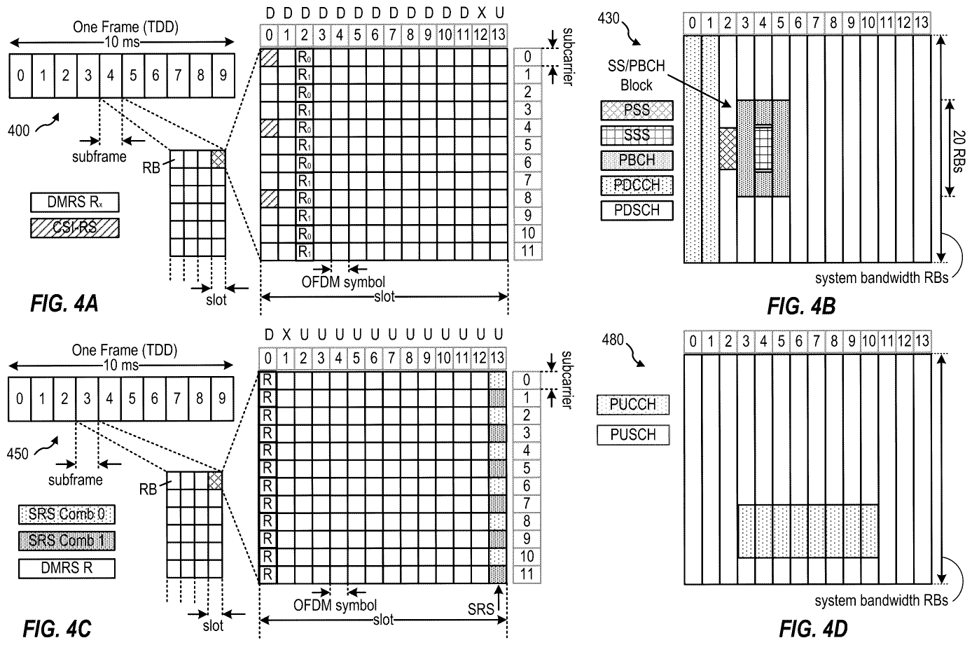

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

Aspects of the present disclosure may describe the performance of certain tasks and the technical solution of various technical problems by application of a specific type of ML model, such as an artificial neural network (ANN). It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such as “AI model,” “ML model,” “AI/ML model,” “trained ML model,” or the like are intended to be interchangeable.

AI/ML techniques have been introduced to help reduce the complexity involved in beam selection and the overhead associated with beam management without sacrificing system performance. For example, with the help of ML techniques, beam selection may be performed in a fraction of the time taken by conventional exhaustive search methods and with performance comparable to that of such methods.

In certain aspects, an ML model is deployed at or on a UE (e.g., such as UE 104 in FIG. 1) or at a network entity (e.g., such as BS 102, network entity 300/302, or an element of a disaggregated base station), for example, for purposes of spatial domain (SD), temporal domain (TD), and/or frequency domain (FD) beam prediction. The TD refers to the analytic space in which signals are conveyed in terms of time, rather than frequency. The FD refers to the analytic space in which signals are conveyed in terms of frequency, rather than time. A scenario where the ML model, at or on the UE, is used to predict SD downlink beams for a set of A-beams based on measurement results of a set of B-beams may be referred to as a beam management case 1, or simply “BM-Case1.” Additionally, a scenario where the ML model, at or on the UE, is used to predict TD downlink beams for a set of A-beams based on the historic measurement results of a set of B-beams may be referred to as a beam management case 2, or simply “BM-Case2.” In general, ML may be used to predict characteristics associated with the set of A-beams, and the set of B-beams may be used for DL beam measurements as input data for the ML. For BM-Case1 and BM-Case2, the beams in the set of A-beams and the set of B-beams may be in the same Frequency Range (e.g., FR1 and/or FR2). In some cases, the set of B-beams may be a subset of the set of A-beams. There may be any number of beams in each of the set of A-beams and the set of B-beams. There may be quasi-colocation (QCL) relationships between the set of A-beams and the set of B-beams.

FIG. 5 is a diagram illustrating example beam prediction 500 by a UE 104. In this example, an ML model 510 is deployed at or on UE 104 to enable UE 104 to make one or more beam predictions based on data input to ML model 510.

For example, a network entity (e.g., a base station or any disaggregated entity thereof) may transmit one or more signals (e.g., SSB(s), DM-RS(s), CSI-RS(s)), via a first set of transmit beams 504, in a first set of communication resources (e.g., an SSB resource, a DM-RS resource, and/or a CSI-RS resource). The UE 104 may perform measurements (e.g., L1-RSRP measurements and/or other measurements) of the one or more signals transmitted in the first set of communication resources, or a subset thereof, to obtain input data, which may include a first set of measurements 512 (sometimes referred to as parameters, channel characteristics, or channel properties). For example, each transmit beam 504 (or a subset thereof), from the first set of beams carrying the one or more signals, may be associated with one or more measurements 512 performed by UE 104. UE 104 may feed the first set of measurements 512 (e.g., L1 RSRP measurement values) into the ML model 510. The UE 104 may further feed information associated with the first set of beams and/or first set of communication resources (or a subset thereof). The information associated with the first set of beams may include a beam direction (e.g., a spatial direction), beam width, beam shape, and/or other characteristics of the respective beam.

The ML model 510 may provide output data, for example, including one or more predictions. More specifically, ML model 510 may provide one or more predicted measurement values 514 for a second set of communication resources associated with a second set of transmit beams 506. The one or more measurement values 514 may include predicted channel characteristics (e.g., predicted L1-RSRP measurement values) associated with the second set of communication resources, where the second set of communication resources are associated with the second set of transmit beams 506.

In some examples, the first set of beams 504 (e.g., that are measured) may be referred to as “Set B beams” and the second set of beams 506 (e.g., that are associated with predicted measurements for the second set of communication resources) may be referred to as “Set A beams.” Put another way, the “Set B beams” are a set of beams for which measurements are taken and used to determine input data based on such measurements for the ML model 510, whereas the “Set A beams” are a set of beams for which ML model 510 performs predictions.

In some examples, first set of beams 504 are a subset of the second set of beams 506. In some other examples, first set of beams 504 and second set of beams 506 are different beams and/or may be mutually exclusive sets. For example, first set of beams 504 may include wide beams (e.g., unrefined beams or beams having a beam width that satisfies a first threshold), and second set of beams 506 may include narrow beams (e.g., refined beams or beams having a beam width that satisfies a second threshold).

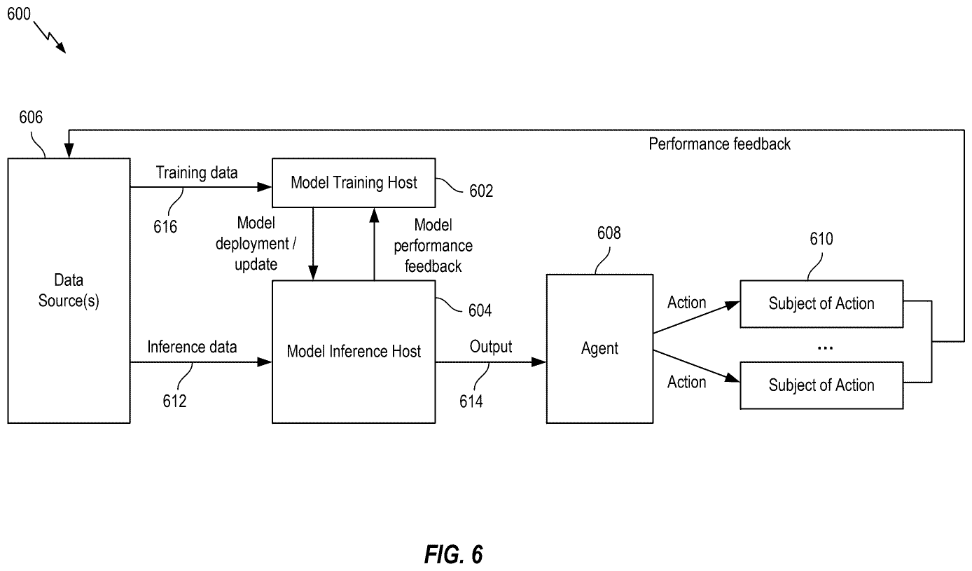

Use of the ML model 510 for beam prediction may reduce a quantity of beam measurements that are performed by UE 104 (e.g., compared to exhaustive search methods described above with respect to FIG. 6), thereby conserving power at UE 104 and/or network resources that would have otherwise been used to measure all beams included in at least the first set of beams.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of the ML model 510 may include a point-direction, an angle of departure (AoD), and/or an angle of arrival (AoA) of a beam included in the second set of beams (e.g., the “Set A beams”). This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to ML model 510. This may enable ML model 510 to output codebook-based and/or non-codebook-based predictions for a measurement value, an AoD, and/or an AoA, among other examples, of a beam at a future time. The output(s) of ML model 510 may facilitate initial access procedures, carrier aggregation (e.g., secondary cell setup), dual connectivity (e.g., secondary cell group (SCG) setup), beam refinement procedures (e.g., a P2 beam management procedure and/or a P3 beam management procedure), link quality or interference adaptation procedures, beam failure and/or beam blockage predictions, and/or radio link failure predictions, among other examples.

In certain aspects, an output of ML model 510 may include a temporal domain (TD) beam prediction. The TD beam prediction may be associated with a serving beam refinement, a link quality (e.g., CQI or PMI) and interference adaptation, a beam failure/blockage prediction, and/or a radio link failure (RLF) prediction.

In certain aspects, ML model 510 performs SD downlink beam predictions for beams included in the “Set A beams” based on measurement results of beams included in the “Set B beams.” In some aspects, ML model 510 performs TD downlink beam prediction for beams included in the “Set A beams” based on historic measurement results of beams included in the “Set B beams.”

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such as “AI model,” “ML model,” “AI/ML model,” “trained ML model,” and the like are intended to be interchangeable.

FIG. 6 is a diagram illustrating an example AI architecture 600 that may be used for AI-enhanced wireless communications. As illustrated, the architecture 600 includes multiple logical entities, such as a model training host 602, a model inference host 604, data source(s) 606, and an agent 608. The AI architecture may be used in any of various use cases for wireless communications, such as those listed above.

The model inference host 604, in the architecture 600, is configured to run an ML model based on inference data 612 provided by data source(s) 606. The model inference host 604 may produce an output 614 (e.g., a prediction or inference, such as a discrete or continuous value) based on the inference data 612, that is then provided as input to the agent 608. In certain aspects, the model inference host 604 may be an example of a model inference agent.

The agent 608 may be an element or an entity of a wireless communication system including, for example, a radio access network (RAN), a wireless local area network, a device-to-device (D2D) communications system, etc. In certain examples, the agent 608 may be an example of a decision agent. In some examples, the agent 608 may be a UE, a base station, or any disaggregated network entity thereof including a CU, a DU, and/or an RU, an access point, a wireless station, a RIC in a cloud-based RAN, among some examples. Additionally, the type of agent 608 may also depend on the type of tasks performed by the model inference host 604, the type of inference data 612 provided to model inference host 604, and/or the type of output 614 produced by model inference host 604.

For example, if output 614 from the model inference host 604 is associated with beam management, the agent 608 may be or include a UE, a DU, or an RU. As another example, if output 614 from model inference host 604 is associated with transmission and/or reception scheduling, the agent 608 may be a CU or a DU.

After the agent 608 receives output 614 from the model inference host 604, agent 608 may determine whether to act based on the output. For example, if agent 608 is a DU or an RU and the output from model inference host 604 is associated with beam management, the agent 608 may determine whether to change or modify a transmit and/or receive beam based on the output 614. If the agent 608 determines to act based on the output 614, agent 608 may indicate the action to at least one subject of the action 610. For example, if the agent 608 determines to change or modify a transmit and/or receive beam for a communication between the agent 608 and the subject of action 610 (e.g., a UE), the agent 608 may send a beam switching indication to the subject of action 610 (e.g., a UE). As another example, the agent 608 may be a UE and the output 614 from model inference host 604 may be one or more predicted channel characteristics for one or more beams. For example, the model inference host 604 may predict channel characteristics for a set of beams based on the measurements of another set of beams. Based on the predicted channel characteristics, the agent 608, such as the UE, may send, to the subject of action 610, such as a BS, a request to switch to a different beam for communications. In some cases, the agent 608 and the subject of action 610 are the same entity.

The data sources 606 may be configured for collecting data that is used as training data 616 for training an ML model, or as inference data 612 for feeding an ML model inference operation. In particular, the data sources 606 may collect data from any of various entities (e.g., the UE and/or the BS), which may include the subject of action 610, and provide the collected data to a model training host 602 for ML model training. For example, after a subject of action 610 (e.g., a UE) receives a beam configuration from agent 608, the subject of action 610 may provide performance feedback associated with the beam configuration to the data sources 606, where the performance feedback may be used by the model training host 602 for monitoring and/or evaluating the ML model performance, such as whether the output 614 provided to agent 608 is accurate. In some examples, if the output 614 provided to agent 608 is inaccurate (or the accuracy is below an accuracy threshold), the model training host 602 may determine to modify or retrain the ML model used by model inference host 604, such as via an ML model deployment/update.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, an ML model is deployed at or on a network entity for RRM prediction for beams (also referred to as RRM prediction or RRM prediction inference). More specifically, a model inference host, such as model inference host 604 in FIG. 6, may be deployed at or on the network entity for predicting measurement values on a first set of beams (SSB or CSI-RS) based on measurements on a second set of beams (SSB or CSI-RS). For the RRM prediction, the measurement object for prediction can contain one or more frequencies (ARFCN), one or more cells, or one or more beams (SSB and/or CSI-RS) per cell or across cells. Similarly, the measurement object for monitoring can contain one or more frequencies (ARFCN), one or more cells, or one or more beams (SSB and/or CSI-RS) per cell or across cells.

In some other aspects, an ML model is deployed at or on a UE for RRM prediction for beams. More specifically, a model inference host, such as model inference host 604 in FIG. 6, may be deployed at or on the UE for predicting measurement values on a first set of beams (SSB or CSI-RS) based on measurements on a second set of beams (SSB or CSI-RS). For the RRM prediction, the measurement object for prediction can contain one or more frequencies (ARFCN), one or more cells, or one or more beams (SSB and/or CSI-RS) per cell or across cells. Similarly, the measurement object for monitoring can contain one or more frequencies (ARFCN), one or more cells, or one or more beams (SSB and/or CSI-RS) per cell or across cells.

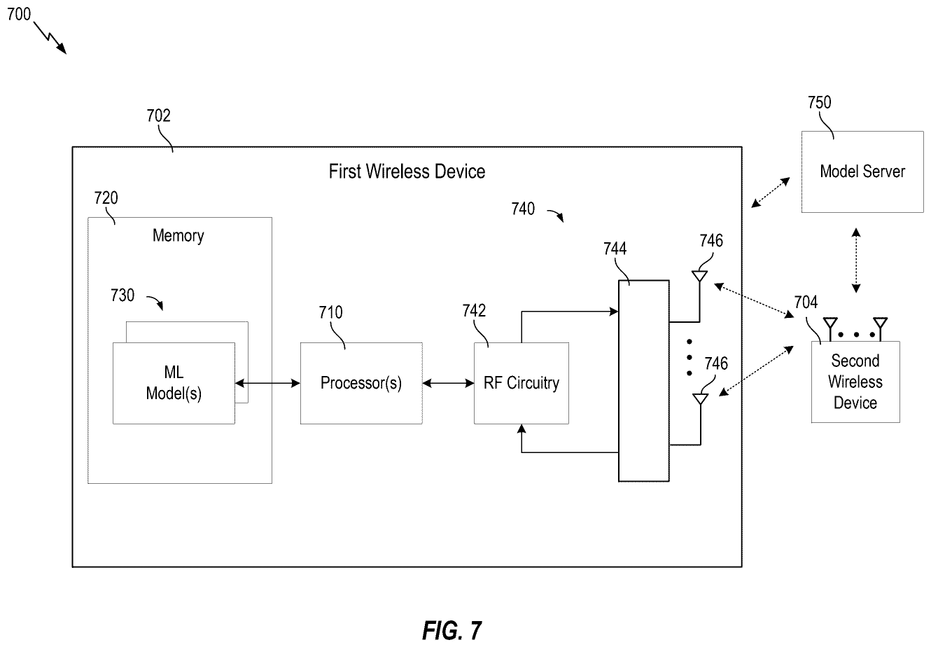

FIG. 7 illustrates an example AI architecture 700 of a first wireless device 702 that is in communication with a second wireless device 704. The first wireless device 702 may be UE 104/304 or NE 300/302 as described herein with respect to FIGS. 1-3. Similarly, the second wireless device 704 may be UE 104/304 or NE 300/302. Note that the AI architecture of the first wireless device 702 may be applied to the second wireless device 704.

The first wireless device 702 may be, or may include, a chip, system on chip (SoC), a system in package (SiP), chipset, package or device that includes one or more processors, processing blocks or processing elements (collectively “the processor 710”) and one or more memory blocks or elements (collectively “the memory 720”).

As an example, in a transmit mode, the processor 710 may transform information (e.g., packets or data blocks) into modulated symbols. As digital baseband signals (e.g., digital in-phase (I) and/or quadrature (Q) baseband signals representative of the respective symbols), the processor 710 may output the modulated symbols to a transceiver 740. The processor 710 may be coupled to the transceiver 740 for transmitting and/or receiving signals via one or more antennas 746. In this example, the transceiver 740 includes radio frequency (RF) circuitry 742, which may be coupled to the antennas 746 via an interface 744. As an example, the interface 744 may include a switch, a duplexer, a diplexer, a multiplexer, and/or the like. The RF circuitry 742 may convert the digital signals to analog baseband signals, for example, using a digital-to-analog converter. The RF circuitry 742 may include any of various circuitry, including, for example, baseband filter(s), mixer(s), frequency synthesizer(s), power amplifier(s), and/or low noise amplifier(s). In some cases, the RF circuitry 742 may upconvert the baseband signals to one or more carrier frequencies for transmission. The antennas 746 may emit RF signals, which may be received at the second wireless device 704.

In receive mode, RF signals received via the antenna 746 (e.g., from the second wireless device 704) may be amplified and converted to a baseband frequency (e.g., downconverted). The received baseband signals may be filtered and converted to digital I or Q signals for digital signal processing. The processor 710 may receive the digital I or Q signals and further process the digital signals, for example, demodulating the digital signals.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first wireless device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the output 614 of FIG. 6) based on input data (e.g., the inference data 612 of FIG. 6), for example, as described herein with respect to the inference host 604 of FIG. 6. The ML model 730 may be used to perform any of various AI-enhanced tasks, such as those listed above.

As an example, the ML model 730 may take measurements of a reference signal (e.g., a first RRM measurement) as input to predict a channel characteristic associated with a different reference signal (e.g., a second RRM measurement). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The output data may include, for example, one or more predicted measurements (or characteristics) of one or more reference or pilot signals, which may be different from the reference or pilot signals associated with the input data. In certain aspects, the one or more reference or pilot signals for which the one or more measurements are predicted may be considered “virtual resources” in that they are not actually transmitted, but the measurements are predicted as though they were transmitted. In certain aspects, the one or more reference or pilot signals for which the one or more measurements are predicted may actually be transmitted but not actually measured by first wireless device 702. Note that other input data and/or output data may be used in addition to or instead of the examples described herein.

In certain aspects, a model server 750 may perform any of various ML model lifecycle management (LCM) tasks for the first wireless device 702 and/or the second wireless device 704. The model server 750 may operate as the model training host 602 and update the ML model 730 using training data. In some cases, the model server 750 may operate as the data source 606 to collect and host training data, inference data, and/or performance feedback associated with an ML model 730. In certain aspects, the model server 750 may host various types and/or versions of the ML models 730 for the first wireless device 702 and/or the second wireless device 704 to download. In some aspects, the model server 750 may perform these tasks based on first reporting and/or second reporting, which may include actual RRM measurements, results of RRM predictions, and/or results of performance monitoring.

In some cases, the model server 750 may monitor and evaluate the performance of the ML model 730 to trigger one or more LCM tasks. For example, the model server 750 may determine whether to activate or deactivate the use of a particular ML model at the first wireless device 702 and/or the second wireless device 704, and the model server 750 may provide such an instruction to the respective first wireless device 702 and/or the second wireless device 704. In some cases, the model server 750 may determine whether to switch to a different ML model 730 being used at the first wireless device 702 and/or the second wireless device 704, and the model server 750 may provide such an instruction to the respective first wireless device 702 and/or the second wireless device 704. In yet further examples, the model server 750 may also act as a central server for decentralized machine learning tasks, such as federated learning.

### Example Artificial Intelligence Model

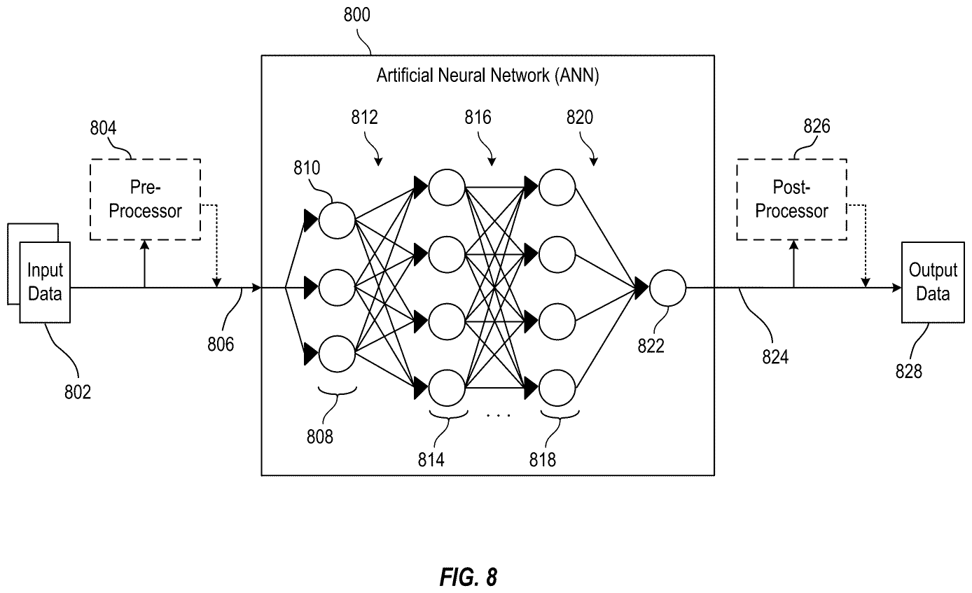

FIG. 8 is an illustrative block diagram of an example artificial neural network (ANN) 800.

ANN 800 may receive input data 806 which may include one or more bits of data 802, pre-processed data output from pre-processor 804 (optional), or some combination thereof. Here, data 802 may include training data, verification data, application-related data, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802.

ANN 800 includes at least one first layer 808 of artificial neurons 810 (e.g., perceptrons) to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824, which may result in output data 828 being different, at least in part, to output data 824, e.g., as a result of data being changed, replaced, deleted, etc. In some implementations, post-processor 826 may be configured to add additional data to output data 824. In this example, second layer 814 and third layer 818 represent intermediate or hidden layers that may be arranged in a hierarchical or other like structure. Although not explicitly shown, there may be one or more further intermediate layers between the second layer 814 and the third layer 818.

The structure and training of artificial neurons 810 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 606 in FIG. 6). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc. Once an initial model has been designed, training of the model may be conducted using training data. Training data may include one or more datasets within which ANN 800 may detect, determine, identify or ascertain patterns. Training data may represent various types of information, including written, visual, audio, environmental context, operational properties, etc. During training, parameters of artificial neurons 810 may be changed, such as to minimize or otherwise reduce a loss function or a cost function. A training process may be repeated multiple times to fine-tune ANN 800 with each iteration.

Various ANN model structures are available for consideration. For example, in a feedforward ANN structure each artificial neuron 810 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 800 or other ML models may be implemented in various types of processing circuits along with memory and applicable instructions therein, for example, as described herein with respect to FIGS. 6 and 7. For example, general-purpose hardware circuits, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

Aspects described herein relate to performance monitoring. Performance monitoring may include computing and/or using KPIs regarding performance of an ML model, such as an ML model used as described herein for RRM prediction. Performance monitoring may include Type 1 performance monitoring (which is performed at the network and optionally with UE assistance) or Type 2 performance monitoring (which is performed at the UE). In Type 1 performance monitoring, a UE may report measurements to the network, and the network may evaluate performance of an ML model (e.g., by computing KPIs according to the measurements and performing LCM operations based on the KPIs). Additionally, or alternatively, the UE may report KPIs or occurrence of a performance monitoring event, based on which the network may evaluate the performance of the ML model. In Type 2 performance monitoring, a UE may compute and report KPIs (e.g., based on dedicated reference signal measurements and/or AI/ML inference outcomes), which the network may use to perform LCM operations for the ML model.

For BM-Case1 and BM-Case2 with a UE-side AI/ML model, the network may support Type 1 performance monitoring, including the following two options: Option 1 (network-side performance monitoring as described above), in which the UE sends a report to the network (for the calculation of performance metric at the network), measurement results from a resource set for monitoring (e.g., L1-RSRP and/or RS index) are supported as the content of the report, and the report is at least configured/triggered by network; and Option 2 (UE-assisted performance monitoring as described above) in which the UE calculates performance metric(s) reports at least a subset of these performance metrics. In some aspects, the UE or network may calculate a Top 1 or Top K beam prediction accuracy (with or without a margin) by comparing the prediction results and the Top 1 or Top K beam based on the measurements from a resource set/resources for monitoring (other approaches are not precluded).

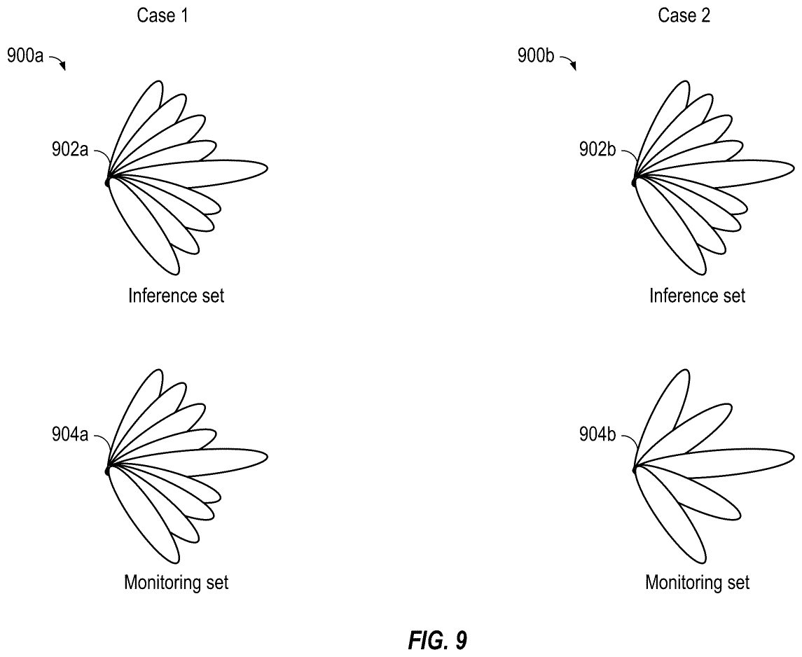

FIG. 9 is a diagram illustrating examples 900 of Layer 3 beam measurement prediction, where the network configures SSB indices and CSI-RS resources, resource sets, or indices for RRM prediction and performance monitoring. A set of beams (e.g., SSB and/or CSI-RS) for prediction and a set of beams (e.g., SSB and/or CSI-RS) for measurement (for monitoring) can be configured using one or more measurement objects. For the RRM prediction, the measurement object for prediction can contain one or more frequencies (ARFCN), one or more cells, or one or more beams (SSB and/or CSI-RS) per cell or across cells. Similarly, the measurement object for monitoring can contain one or more frequencies (ARFCN), one or more cells, or one or more beams (SSB and/or CSI-RS) per cell or across cells.

Example 900a is an example where a size of the prediction targets for inference 902a (that is, the set of one or more frequencies (ARFCN), one or more cells, or one or more beams (SSB and/or CSI-RS) per cell or across cells for which RRM prediction is performed) is the same as a size of the measurement targets for performance monitoring 904a (that is, the set of one or more frequencies (ARFCN), one or more cells, or one or more beams (SSB and/or CSI-RS) per cell or across cells for which performance monitoring is performed). A “size of prediction targets” may refer to a number of prediction targets. A “size of measurement targets” may refer to a number of measurement targets. For example, the set 902a and the set 904a may include the same set of frequencies (ARFCN), cells, or beams (SSB and/or CSI-RS) per cell or across cells, or the like. Example 900a may be referred to as “Case 1.”

Example 900b is an example where the set of frequencies (ARFCN), cells, or beams (SSB and/or CSI-RS) per cell or across cells 902b is different than the set of frequencies (ARFCN), cells, or beams (SSB and/or CSI-RS) per cell or across cells 904b. For example, the set 902b may have a number of frequencies (ARFCN), cells, or beams (SSB and/or CSI-RS) per cell or across cells, and the set 904b may include a second, smaller number of frequencies (ARFCN), cells, or beams (SSB and/or CSI-RS) per cell or across cells. In some aspects, the set 904b may include a subset of the first set of frequencies (ARFCN), cells, or beams (SSB and/or CSI-RS) per cell or across cells. Example 900b may be referred to as “Case 2.”

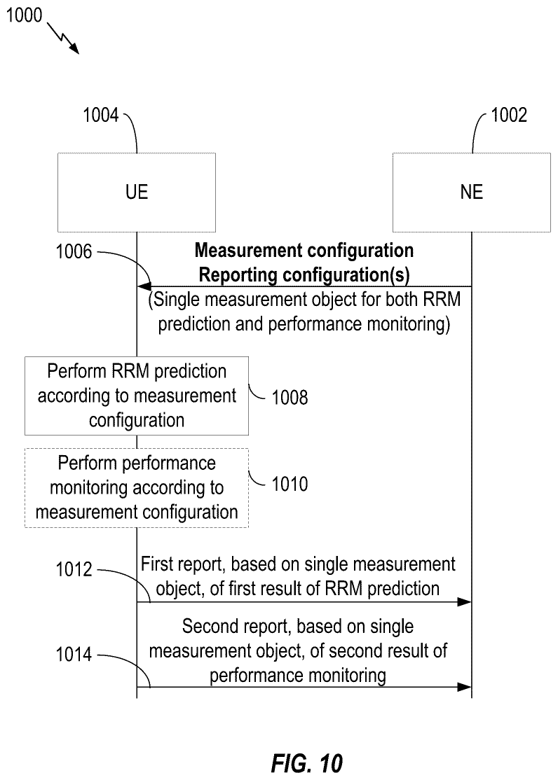

FIG. 10 is a diagram illustrating an example 1000 of signaling for RRM prediction and performance monitoring reporting. Example 1000 is an example where the prediction targets for inference (e.g., set 902a of example 900a) are the same as the measurement targets for performance monitoring (e.g., set 904a of example 900a).

At 1006, the network entity 1004 may transmit, and the UE 1002 may receive, a measurement configuration. For example, the network entity 1004 may transmit the measurement configuration via one or more RRC messages. In some aspects, the measurement configuration may include one or more measurement object indications (such as an RRC information element (IE) such as “MeasIDToAddMod”) which indicates one or more measurement identities (via one or more RRC IEs “MeasID”) to be configured for the UE 1002. A measurement identity may indicate one or more measurement objects (e.g., via a measurement object identifier, which may be included in an RRC IE “measObjectID”) and one or more report configurations (e.g., via a report configuration identifier, which may be included in an RRC IE “ReportConfigID”). Thus, a measurement object indication (e.g., “MeasIDToAddMod”) may indicate a measurement object (e.g., via “MeasID”).

As mentioned, in example 1000, the prediction targets for inference (e.g., set 902a of example 900a) are the same as or are the measurement targets for performance monitoring (e.g., set 904a of example 900a). In example 1000, a single measurement object can be used for both RRM prediction and performance monitoring. For example, the measurement configuration may indicate a first measurement object for RRM prediction, wherein the first measurement object is the given measurement object. The measurement configuration may also indicate a second measurement object for performance monitoring, where the second measurement object is also the given measurement object. Thus, a single measurement object (e.g., measObject) is used for both inference and monitoring measurement object configuration.

In example 1000, two reporting configurations may be defined. For example, the measurement configuration may indicate a first reporting configuration (e.g., a first ReportConfigID) for RRM prediction, and may indicate a second reporting configuration (e.g., a second ReportConfigID) for performance monitoring. In some aspects, the first reporting configuration may be configured via or indicated in a first measurement configuration and/or a first measurement object indication, and the second reporting configuration may be configured via or indicated in a second measurement configuration and/or a second measurement object indication. For example, a reportConfigID for inference may be included in MeasIDToAddMod for monitoring. Thus, two reportConfigs are defined: one for inference result reporting containing a reportConfigID for inference, and another for monitoring result reporting containing a reportConfigID for monitoring.

In some aspects, a reporting configuration for RRM prediction (e.g., reportConfigID for inference) may be included in a second measurement object indication (or a measurement configuration including the second measurement object indication) that is associated with performance monitoring. This facilitates reporting of RRM prediction results together with performance monitoring results, as described below.

At 1008, the UE 1004 performs RRM prediction according to the measurement configuration(s). For example, the UE 1004 may generate a first result of RRM prediction for the prediction targets for inference indicated by the single measurement object identified by the measurement configuration.

At 1010, the UE 1004 optionally performs performance monitoring according to the measurement configuration(s). For example, the UE 1004 may compare the RRM prediction at 1008 to one or more measured values, such as one or more measured values on the set of frequencies (ARFCN), cells, or beams (SSB and/or CSI-RS) per cell or across cells by the single measurement object identified by the measurement configuration. Additionally, or alternatively, the UE 1004 may identify a number of cells or beams (SSB and/or CSI-RS) per cell or across cells identified as a top cell or beam (SSB and/or CSI-RS) per cell or across cells or top K cells or beams (SSBs and CSI-RSs) per cell or across cells according to the RRM prediction, and may identify any overlap between the cells or beams (SSB and/or CSI-RS) per cell or across cells and a set of measured reference signals or resources (e.g., beams) identified as top cell or beam (SSB and/or CSI-RS) per cell or across cells or top K beams (SSB and/or CSI-RS) per cell or across cells.

At 1012, the UE 1004 transmits, and the network entity 1002 receives, a first report of a first result based on the single measurement object. The first result may be a first result of RRM prediction with regard to the set of frequencies (ARFCN), cells, or beams (SSB and/or CSI-RS) per cell or across cells indicated by the single measurement object. At 1014, the UE 1004 transmits, and the network entity 1002 receives, a second result based on the single measurement object. The second result may be a second result of performance monitoring with regard to the set of frequencies (ARFCN), cells, or beams (SSB and/or CSI-RS) per cell or across cells indicated by the single measurement object, such as a set of KPIs, a set of calculated values used to determine KPIs, or the like. In some aspects, the first report and the second report may be transmitted in a single report (e.g., information of the first report and information of the second report may be transmitted as part of a single report such as the second report). In some other aspects, the first report may be transmitted separately from the second report.

The second report may include, or be associated with, an indication of the first measurement object associated with the RRM prediction. For example, in example 1000, the first report and the second report may be included in a same report referred to as a second report, and/or the second report may include the first result. In some aspects, this may be because a reportConfigID for the RRM prediction is included in a measurement object indication (e.g., MeasIDToAddMod) for the performance monitoring. In some aspects, the second report (e.g., an IE of the second report such as MeasResult) may include both the RRM prediction (e.g., the first result) and measurements (such as a measurement on a set of frequencies (ARFCN), cells, or beams (SSB and/or CSI-RS) per cell or across cells indicated by the single measurement object, which may include the second result). In such examples, the second report may include an indicator that differentiates the RRM prediction from the measurement information. Additionally, or alternatively, the second report may be structured such that the measurement information is differentiated from the RRM prediction (e.g., in different portions of the second report, such as different fields, different IE structures, or the like).

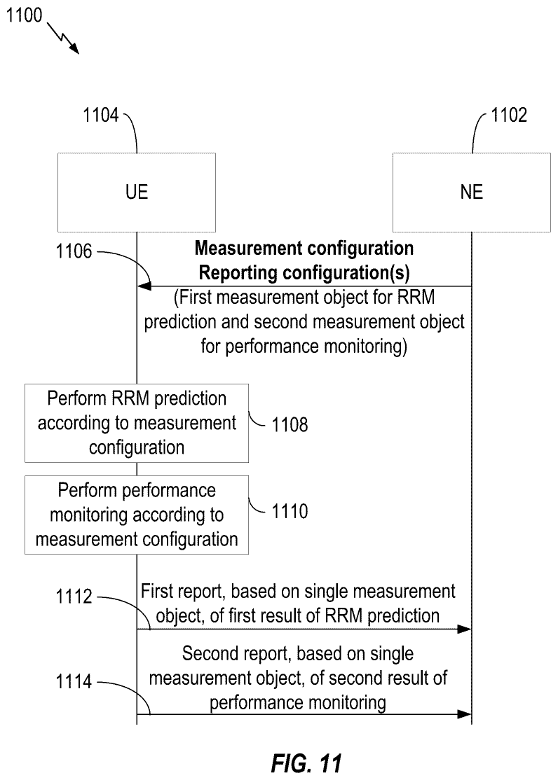

FIG. 11 is a diagram illustrating another example 1100 of signaling for RRM prediction and performance monitoring reporting. Example 1100 is an example where the set of frequencies (ARFCN), cells, or beams (SSB and/or CSI-RS) per cell or across cells for inference (e.g., set 902b of example 900b) is the same as the performance monitoring set of frequencies (ARFCN), cells, or beams (SSB and/or CSI-RS) per cell or across cells (e.g., set 904b of example 900b).

At 1106, the network entity 1104 may transmit, and the UE 1102 may receive, a measurement configuration. For example, the network entity 1104 may transmit the measurement configuration via one or more RRC messages. In some aspects, the measurement configuration may include an RRC IE such as “MeasIDToAddMod,” which indicates one or more measurement identities (via one or more RRC IEs “MeasID”) to be configured for the UE 1102. A measurement identity may indicate one or more measurement objects (e.g., via a measurement object identifier, which may be included in an RRC IE “measObjectID”) and one or more report configurations (e.g., via a report configuration identifier, which may be included in an RRC IE “ReportConfigID”).

As mentioned, in example 1100, a set of frequencies (ARFCN), cells, or beams (SSB and/or CSI-RS) per cell or across cells for RRM prediction (e.g., set 902b of example 900b) is different than a set of frequencies (ARFCN), cells, or beams (SSB and/or CSI-RS) per cell or across cells for performance monitoring (e.g., set 904b of example 900b). In example 1100, a first measurement object is used for RRM prediction, and a second measurement object is used for performance monitoring. For example, the measurement configuration may indicate a first measurement object for RRM prediction, and this first measurement object may indicate the set of frequencies (ARFCN), cells, or beams (SSB and/or CSI-RS) per cell or across cells for inference. The measurement configuration may also indicate a second measurement object for performance monitoring, and this second measurement object may indicate the set of frequencies (ARFCN), cells, or beams (SSB and/or CSI-RS) per cell or across cells for performance monitoring. Thus, two measObjectIDs are defined: one for the RRM prediction measObject, and another for the performance monitoring measObject.

In example 1100, two reporting configurations may be defined. For example, the measurement configuration may indicate a first reporting configuration (e.g., a first ReportConfigID) for RRM prediction, and may indicate a second reporting configuration (e.g., a second ReportConfigID) for performance monitoring. “ReportConfigID” may be referred to herein as a reporting configuration identifier. In some aspects, the first reporting configuration may be configured via or indicated in a first measurement configuration and/or a first measurement object indication, and the second reporting configuration may be configured via or indicated in a second measurement configuration and/or a second measurement object indication. Thus, two reportConfigs are defined: one for inference result reporting containing a reportConfigID for inference, and another for monitoring result reporting containing a reportConfigID for monitoring.

In some aspects, the measurement configuration may indicate multiple measurement objects. For example, a measurement object indication (e.g., MeasIDToAddMod) for performance monitoring may indicate a first measurement object (e.g., a first MeasObjectID) for RRM prediction and a second measurement object (e.g., a second MeasObjectID) for performance monitoring. This may facilitate reporting of RRM prediction results with performance monitoring results, thereby providing an indication, in a report of the performance monitoring results, of the RRM prediction results. Additionally, or alternatively, the measurement configuration may indicate multiple reporting configurations. For example, the measurement configuration may indicate a first reporting configuration for RRM prediction (e.g., a first ReportConfigID) and a second reporting configuration for performance monitoring. Thus, the RRM prediction results and the performance monitoring results can be reported together, thereby providing an indication, in a report of the performance monitoring results, of the RRM prediction results.

At 1108, the UE 1104 performs RRM prediction according to the measurement configuration(s). For example, the UE 1104 may generate a first result of RRM prediction for the set of frequencies (ARFCN), cells, or beams (SSB and/or CSI-RS) per cell or across cells indicated by the first measurement object identified by the measurement configuration.

At 1110, the UE 1104 optionally performs performance monitoring according to the measurement configuration(s). For example, the UE 1104 may compare the RRM prediction at 1108 to one or more measured values, such as one or more measured values on the set of frequencies (ARFCN), cells, or beams (SSB and/or CSI-RS) per cell or across cells indicated by the second measurement object identified by the measurement configuration. Additionally, or alternatively, the UE 1104 may identify a number of cells or beams (SSB and/or CSI-RS) per cell or across cells identified as a top cell or beam (SSB and/or CSI-RS) per cell or across cells or top K cells or beams (SSBs and CSI-RSs) per cell or across cells according to the RRM prediction, and may identify any overlap between the cells or beams (SSB and/or CSI-RS) per cell or across cells and a set of measured reference signals or resources (e.g., beams) identified as top cell or beam (SSB and/or CSI-RS) per cell or across cells or top K beams (SSB and/or CSI-RS) per cell or across cells.

At 1112, the UE 1104 transmits, and the network entity 1102 receives, a first report of a first result based on the single measurement object. The first result may be a first result of RRM prediction with regard to the set of frequencies (ARFCN), cells, or beams (SSB and/or CSI-RS) per cell or across cells indicated by the first measurement object. At 1114, the UE 1004 transmits, and the network entity 1102 receives, a second result based on the single measurement object. The second result may be a second result of performance monitoring with regard to the set of frequencies (ARFCN), cells, or beams (SSB and/or CSI-RS) per cell or across cells indicated by the second measurement object, such as a set of KPIs, a set of calculated values used to determine KPIs, or the like. In some aspects, the first report and the second report may be transmitted in a single report (e.g., information of the first report and information of the second report may be transmitted as part of a single report such as the second report). In some other aspects, the first report may be transmitted separately from the second report.

The second report may include, or be associated with, an indication of the first measurement object associated with the RRM prediction. For example, in example 1100, the first report and the second report may be included in a same report referred to as a second report, and/or the second report may include the first result. In some aspects, this may be because a reportConfigID for the RRM prediction is included in a measurement object indication (e.g., MeasIDToAddMod) for the performance monitoring, or vice versa. In some aspects, the second report (e.g., an IE of the second report such as MeasResult) may include both the RRM prediction (e.g., the first result) and measurement information (such as a measurement on a resource indicated by the single measurement object, which may include the second result). In such examples, the second report may include an indicator that differentiates the RRM prediction from the measurement information. Additionally, or alternatively, the second report may be structured such that the measurement information is differentiated from the RRM prediction (e.g., different fields, different IE structures, or the like). Additionally, or alternatively, the RRM prediction (e.g., the first result) may be differentiated from the measurement information (e.g., the second result) based on the first measurement object and the second measurement object, respectively.

In some aspects, the UE 1004 or the UE 1104 may perform the second reporting described herein (such as the second report at 1014 or 1114) at each of a plurality of monitoring occasions. For example, the measurement configuration may indicate a set of monitoring occasions associated with the performance monitoring. The UE 1004/1104 may report the second result (e.g., may calculate KPIs and report the KPIs) at each of the set of monitoring occasions. In some other aspects, the UE 1004/1104 may calculate the KPIs at each monitoring occasion of the set of monitoring occasions, and may report a combination of the KPIs (as calculated at each monitoring occasion). For example, the UE 1004/1104 may average the KPIs, may perform a weighted averaging of the KPIs, or the like. This combination can be linear scale averaging, log scale averaging, or the like. In such examples, the UE 1004/1104 can report second results such as accuracy, recall, an F1 score, a receiver operating characteristic (ROC) value, an area under the curve (AUC) value, or the like.

### Example Operations of a User Equipment

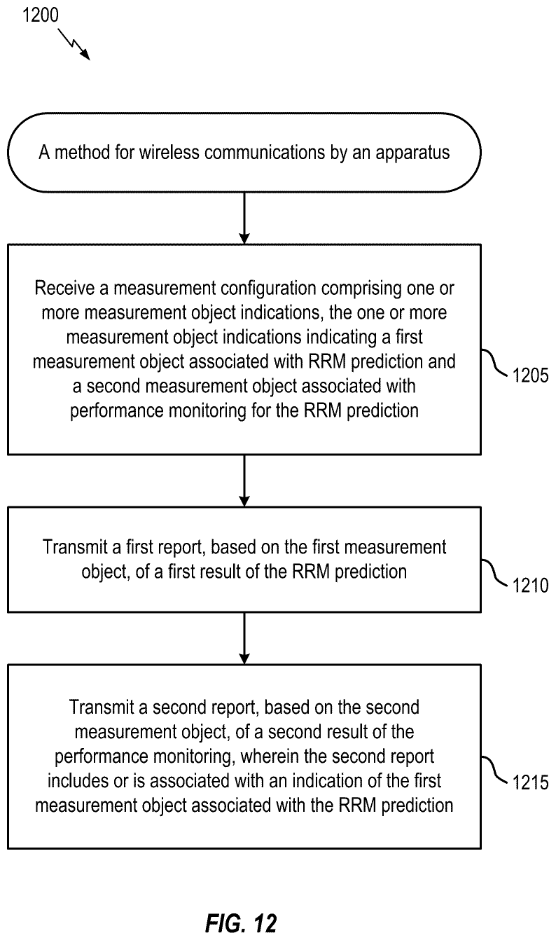

FIG. 12 shows a method 1200 for wireless communications by an apparatus, such as UE 104 of FIG. 1 or UE 304 of FIG. 3.

Method 1200 begins at block 1205 with receiving a measurement configuration comprising one or more measurement object indications, the one or more measurement object indications indicating a first measurement object associated with RRM prediction (e.g., indicating prediction targets for inference) and a second measurement object associated with performance monitoring (e.g., indicating measurement targets for performance monitoring) for the RRM prediction.

Method 1200 then proceeds to block 1210 with transmitting a first report, based on the first measurement object, of a first result of the RRM prediction. The first report may be based on the first measurement object (which may in some examples such as example 1000 be a single measurement object) in that the first report indicates a first result derived from RRM prediction regarding reference signals or resources indicated by the first measurement object.

Method 1200 then proceeds to block 1215 with transmitting a second report, based on the second measurement object, of a second result of the performance monitoring, wherein the second report includes or is associated with an indication of the first measurement object associated with the RRM prediction. The second report may be based on the second measurement object (which may in some examples such as example 1000 be a single measurement object) in that the second report indicates a second result derived from performance monitoring regarding RRM prediction on reference signals or resources indicated by the second measurement object.

In some aspects, the first measurement object and the second measurement object are a same measurement object.

In some aspects, the first report is based on a first reporting configuration containing a report configuration identifier for the RRM prediction and the second report is based on a second reporting configuration containing a report configuration identifier for the performance monitoring.

In some aspects, the indication of the first measurement object is a measurement identity that indicates the first measurement object.

In some aspects, the measurement identity further indicates a report configuration identifier for the RRM prediction.

In some aspects, the same measurement object is used for configuring measurement objects for both RRM prediction and performance monitoring.

In some aspects, the same measurement object is configured for reporting the first result based on a first report configuration identifier for the RRM prediction and for reporting a measurement result based on a second report configuration identifier for the performance monitoring.

In some aspects, the indication of the first measurement object comprises the first report, wherein the first report is sent with the second report.

In some aspects, the first measurement object is different than the second measurement object.

In some aspects, the indication of the first measurement object is a measurement identity that indicates the first measurement object.

In some aspects, the one or more measurement object indications include a first measurement object indication that indicates the first measurement object and a second measurement object indication that indicates the second measurement object.

In some aspects, the second measurement object indication further indicates a first report configuration for the first report and a second report configuration for the second report.

In some aspects, the first report and the second report are included in a single report.

In some aspects, the single report includes a first indication of the first measurement object or a second indication of the second measurement object.

In some aspects, the single report includes a first portion for the first result and a second portion for the second result.

In some aspects, block 1215 includes transmitting the second report at each of a set of configured monitoring occasions.

In some aspects, transmitting the second report comprises transmitting the second report based on a monitoring window, wherein the second result is based on a set of monitoring occasions in the monitoring window.

In some aspects, method 1200 further includes combining a set of indicators that are based on measurements in the set of monitoring occasions to generate the second result.

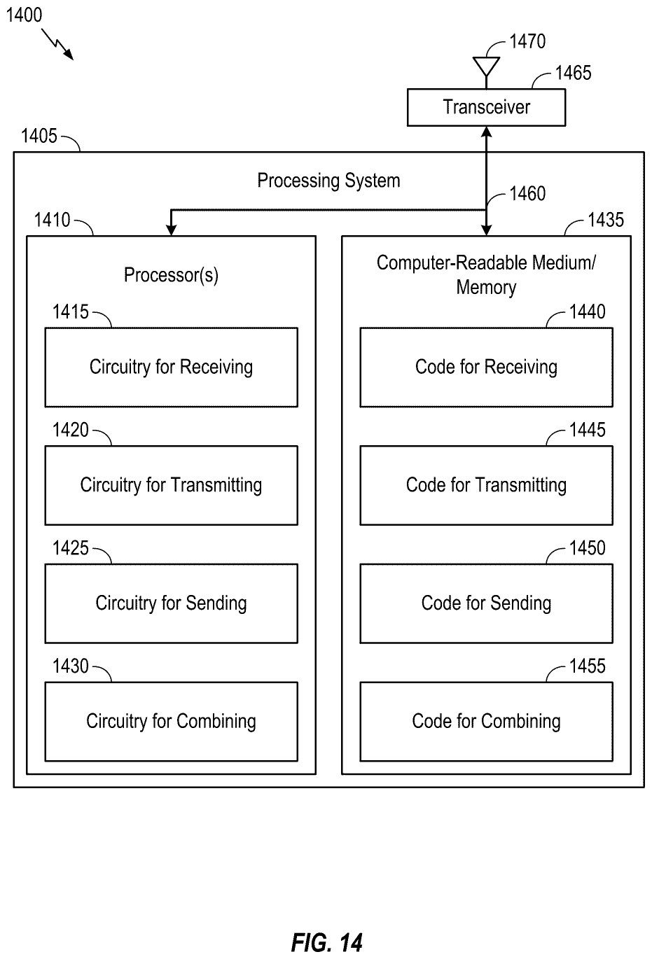

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Operations of a Network Entity

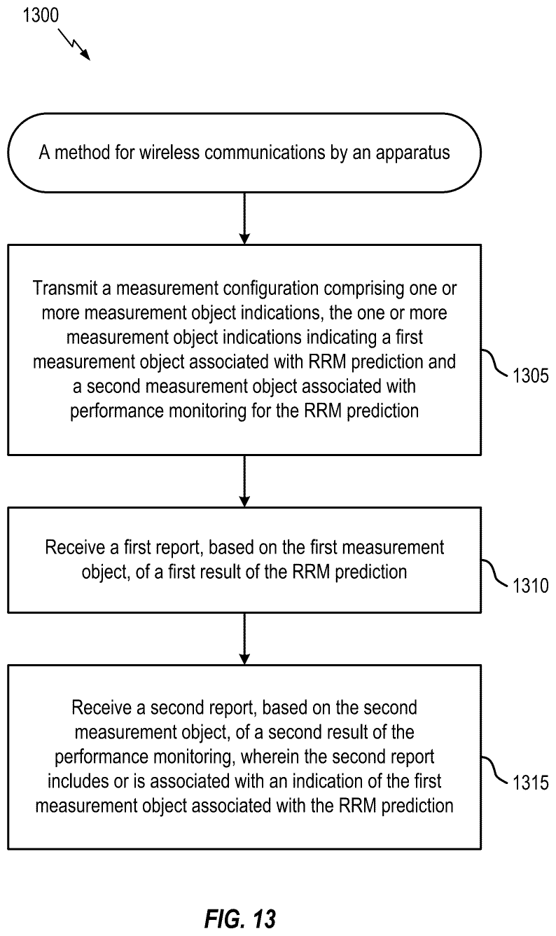

FIG. 13 shows a method 1300 for wireless communications by an apparatus, such as BS 102 of FIG. 1, a first network entity 300 or second network entity 302 of FIG. 3, or a disaggregated base station as discussed with respect to FIG. 2.

Method 1300 begins at block 1305 with transmitting a measurement configuration comprising one or more measurement object indications, the one or more measurement object indications indicating a first measurement object associated with RRM prediction and a second measurement object associated with performance monitoring for the RRM prediction.

Method 1300 then proceeds to block 1310 with receiving a first report, based on the first measurement object, of a first result of the RRM prediction.

Method 1300 then proceeds to block 1315 with receiving a second report, based on the second measurement object, of a second result of the performance monitoring, wherein the second report includes or is associated with an indication of the first measurement object associated with the RRM prediction.

In some aspects, the first measurement object and the second measurement object are a same measurement object.

In some aspects, the first report is based on a first reporting configuration containing a report configuration identifier for the RRM prediction and the second report is based on a second reporting configuration containing a report configuration identifier for the performance monitoring.

In some aspects, the indication of the first measurement object is a measurement identity that indicates the first measurement object.

In some aspects, the measurement identity further indicates a report configuration identifier for the RRM prediction.

In some aspects, the same measurement object is used for configuring measurement objects for both RRM prediction and performance monitoring.

In some aspects, the same measurement object is configured for reporting the first result based on a first report configuration identifier for the RRM prediction and for reporting a measurement result based on a second report configuration identifier for the performance monitoring.

In some aspects, the indication of the first measurement object comprises the first report, wherein the first report is sent with the second report.

In some aspects, the first measurement object is different than the second measurement object.

In some aspects, the indication of the first measurement object is a measurement identity that indicates the first measurement object.

In some aspects, the one or more measurement object indications include a first measurement object indication that indicates the first measurement object and a second measurement object indication that indicates the second measurement object.

In some aspects, the second measurement object indication further indicates a first report configuration for the first report and a second report configuration for the second report.

In some aspects, the first report and the second report are included in a single report.

In some aspects, the single report includes a first indication of the first measurement object or a second indication of the second measurement object.

In some aspects, the single report includes a first portion for the first result and a second portion for the second result.

In some aspects, block 1315 includes receiving the second report at each of a set of configured monitoring occasions.

In some aspects, block 1315 includes receiving the second report based on a monitoring window, wherein the second result is based on a set of monitoring occasions in the monitoring window.

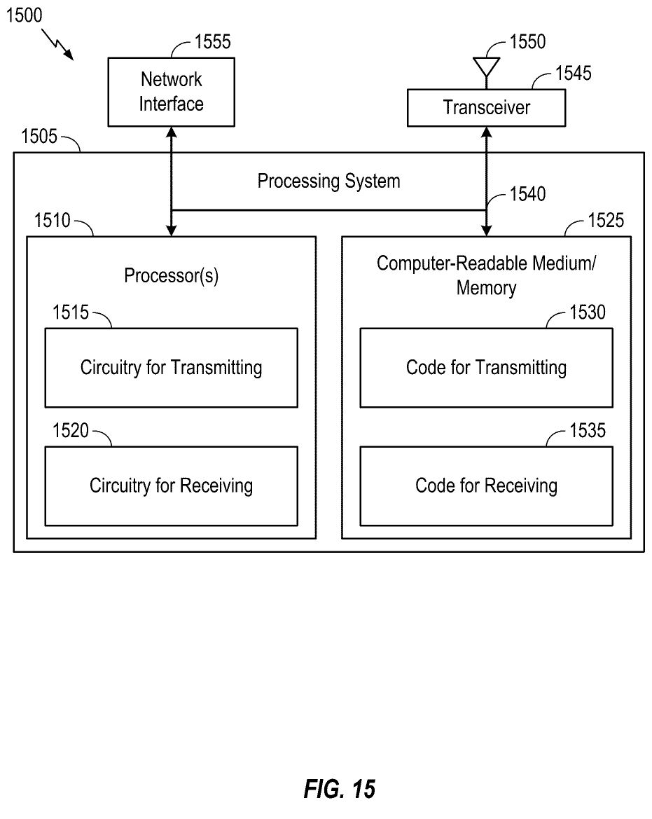

In some aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1465 (e.g., a transmitter and/or a receiver). The transceiver 1465 is configured to transmit and receive signals for the communications device 1400 via an antenna 1470, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1435. In various aspects, the one or more processors 1410 may be representative of the one or more processors 318 described with respect to FIG. 3. The one or more processors 1410 are coupled to a computer-readable medium/memory 1435 via a bus 1460. In some aspects, the computer-readable medium/memory 1435 may be representative of the one or more memories 320 described with respect to FIG. 3. The computer-readable medium/memory 1435 is a non-transitory computer-readable medium/memory. In certain aspects, the computer-readable medium/memory 1435 is configured to store instructions (e.g., computer-executable code), that when executed by the one or more processors 1410, cause the one or more processors 1410 to perform the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1435 stores code (e.g., executable instructions), including code for receiving 1440, code for transmitting 1445, code for sending 1450, and code for combining 1455. Processing of the code 1440-1455 may enable and cause the communications device 1400 to perform the method 1200 described with respect to FIG. 12, or any aspect related to it. For instance, in some aspects, code for receiving 1440 includes code for receiving a measurement configuration comprising one or more measurement object indications, the one or more measurement object indications indicating a first measurement object associated with RRM prediction and a second measurement object associated with performance monitoring for the RRM prediction. In some aspects, code for transmitting 1445 includes code for transmitting a first report, based on the first measurement object, of a first result of the RRM prediction. In some aspects, code for transmitting 1445 includes code for transmitting a second report, based on the second measurement object, of a second result of the performance monitoring, wherein the second report includes or is associated with an indication of the first measurement object associated with the RRM prediction.

The one or more processors 1410 include circuitry configured to implement (e.g., execute) the code stored in the computer-readable medium/memory 1435, including circuitry for receiving 1415, circuitry for transmitting 1420, circuitry for sending 1425, and circuitry for combining 1430. Processing with circuitry 1415-1430 may enable and cause the communications device 1400 to perform the method 1200 described with respect to FIG. 12, or any aspect related to it. For instance, in some aspects, circuitry for receiving 1415 includes circuitry for receiving a measurement configuration comprising one or more measurement object indications, the one or more measurement object indications indicating a first measurement object associated with RRM prediction and a second measurement object associated with performance monitoring for the RRM prediction. In some aspects, circuitry for transmitting 1420 includes circuitry for transmitting a first report, based on the first measurement object, of a first result of the RRM prediction. In some aspects, circuitry for transmitting 1420 includes circuitry for transmitting a second report, based on the second measurement object, of a second result of the performance monitoring, wherein the second report includes or is associated with an indication of the first measurement object associated with the RRM prediction.

More generally, means for communicating, transmitting, sending or outputting for transmission may include the one or more transceivers 324, one or more antenna 322 and/or processing system 316 of the UE 304 illustrated in FIG. 3, transceiver 1465 and/or antenna 1470 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1465 and/or antenna 1470 of the communications device 1400 in FIG. 14, and/or one or more processors 1410 of the communications device 1400 in FIG. 14.

FIG. 15 depicts aspects of an example communications device configured for wireless communications. In some aspects, communications device 1500 is a network entity, such as BS 102 of FIG. 1, first network entity 300 or second network entity 302 of FIG. 3, or a disaggregated base station as discussed with respect to FIG. 2.

The communications device 1500 includes a processing system 1505 coupled to a transceiver 1545 (e.g., a transmitter and/or a receiver) and/or a network interface 1555. The transceiver 1545 is configured to transmit and receive signals for the communications device 1500 via an antenna 1550, such as the various signals as described herein. The network interface 1555 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510 and a computer-readable medium/memory 1525. In various aspects, one or more processors 1510 may be representative of the one or more processors 308, as described with respect to FIG. 3. The one or more processors 1510 are coupled to the computer-readable medium/memory 1525 via a bus 1540. In certain aspects, the computer-readable medium/memory 1525 is configured to store instructions (e.g., computer-executable code), including code 1530 and 1535, that when executed by the one or more processors 1510, cause the one or more processors 1510 to perform the method 1300 described with respect to FIG. 13, or any aspect related to it, including any operations described in relation to FIG. 13. The computer-readable medium/memory 1525 is a non-transitory computer-readable medium/memory. Note that reference to a processor of communications device 1500 performing a function may include one or more processors of communications device 1500 performing that function, such as in a distributed fashion.

In the depicted example, the computer-readable medium/memory 1525 stores code (e.g., executable instructions), including code for transmitting 1530 and code for receiving 1535. Processing of the code 1530 and 1535 may enable and cause the communications device 1500 to perform the method 1300 described with respect to FIG. 13, or any aspect related to it. For instance, in some aspects, code for transmitting 1530 includes code for transmitting a measurement configuration comprising one or more measurement object indications, the one or more measurement object indications indicating a first measurement object associated with RRM prediction and a second measurement object associated with performance monitoring for the RRM prediction. In some aspects, code for receiving 1535 includes code for receiving a first report, based on the first measurement object, of a first result of the RRM prediction. In some aspects, code for receiving 1535 includes code for receiving a second report, based on the second measurement object, of a second result of the performance monitoring, wherein the second report includes or is associated with an indication of the first measurement object associated with the RRM prediction.

The one or more processors 1510 include circuitry configured to implement (e.g., execute) the code stored in the computer-readable medium/memory 1525, including circuitry for transmitting 1515 and circuitry for receiving 1520. Processing with circuitry 1515 and 1520 may enable and cause the communications device 1500 to perform the method 1300 described with respect to FIG. 13, or any aspect related to it. For instance, in some aspects, circuitry for transmitting 1515 includes circuitry for transmitting a measurement configuration comprising one or more measurement object indications, the one or more measurement object indications indicating a first measurement object associated with RRM prediction and a second measurement object associated with performance monitoring for the RRM prediction. In some aspects, circuitry for receiving 1520 includes circuitry for receiving a first report, based on the first measurement object, of a first result of the RRM prediction. In some aspects, circuitry for receiving 1520 includes circuitry for receiving a second report, based on the second measurement object, of a second result of the performance monitoring, wherein the second report includes or is associated with an indication of the first measurement object associated with the RRM prediction.

Various components of the communications device 1500 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15. Means for communicating, receiving or obtaining may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15.

### Example Clauses

Implementation examples are described in the following numbered clauses:

Clause 1: A method for wireless communications by an apparatus comprising: receiving a measurement configuration comprising one or more measurement object indications, the one or more measurement object indications indicating a first measurement object associated with RRM prediction and a second measurement object associated with performance monitoring for the RRM prediction; transmitting a first report, based on the first measurement object, of a first result of the RRM prediction; and transmitting a second report, based on the second measurement object, of a second result of the performance monitoring, wherein the second report includes or is associated with an indication of the first measurement object associated with the RRM prediction.

Clause 2: The method of Clause 1, wherein the first measurement object and the second measurement object are a same measurement object.

Clause 3: The method of Clause 2, wherein the first report is based on a first reporting configuration containing a report configuration identifier for the RRM prediction and the second report is based on a second reporting configuration containing a report configuration identifier for the performance monitoring.

Clause 4: The method of Clause 2, wherein the indication of the first measurement object is a measurement identity that indicates the first measurement object.

Clause 5: The method of Clause 4, wherein the measurement identity further indicates a report configuration identifier for the RRM prediction.

Clause 6: The method of Clause 2, wherein the same measurement object is used for configuring measurement objects for both RRM prediction and performance monitoring.

Clause 7: The method of Clause 6, wherein the same measurement object is configured for reporting the first result based on a first report configuration identifier for the RRM prediction and for reporting a measurement result based on a second report configuration identifier for the performance monitoring.

Clause 8: The method of Clause 2, wherein the indication of the first measurement object comprises the first report, wherein the first report is sent with the second report.

Clause 9: The method of any one of Clauses 1-8, wherein the first measurement object is different than the second measurement object.

Clause 10: The method of Clause 9, wherein the indication of the first measurement object is a measurement identity that indicates the first measurement object.

Clause 11: The method of Clause 9, wherein the one or more measurement object indications include a first measurement object indication that indicates the first measurement object and a second measurement object indication that indicates the second measurement object.

Clause 12: The method of Clause 11, wherein the second measurement object indication further indicates a first report configuration for the first report and a second report configuration for the second report.

Clause 13: The method of Clause 9, wherein the first report and the second report are included in a single report.

Clause 14: The method of Clause 13, wherein the single report includes a first indication of the first measurement object or a second indication of the second measurement object.

Clause 15: The method of Clause 13, wherein the single report includes a first portion for the first result and a second portion for the second result.

Clause 16: The method of any one of Clauses 1-15, wherein transmitting the second report comprises transmitting the second report at each of a set of configured monitoring occasions.

Clause 17: The method of any one of Clauses 1-16, wherein transmitting the second report comprises transmitting the second report based on a monitoring window, wherein the second result is based on a set of monitoring occasions in the monitoring window.

Clause 18: The method of Clause 17, further comprising combining a set of indicators that are based on measurements in the set of monitoring occasions to generate the second result.

Clause 19: A method for wireless communications by an apparatus comprising: transmitting a measurement configuration comprising one or more measurement object indications, the one or more measurement object indications indicating a first measurement object associated with RRM prediction and a second measurement object associated with performance monitoring for the RRM prediction; receiving a first report, based on the first measurement object, of a first result of the RRM prediction; and receiving a second report, based on the second measurement object, of a second result of the performance monitoring, wherein the second report includes or is associated with an indication of the first measurement object associated with the RRM prediction.

Clause 20: The method of Clause 19, wherein the first measurement object and the second measurement object are a same measurement object.

Clause 21: The method of Clause 20, wherein the first report is based on a first reporting configuration containing a report configuration identifier for the RRM prediction and the second report is based on a second reporting configuration containing a report configuration identifier for the performance monitoring.

Clause 22: The method of Clause 20, wherein the indication of the first measurement object is a measurement identity that indicates the first measurement object.

Clause 23: The method of Clause 22, wherein the measurement identity further indicates a report configuration identifier for the RRM prediction.

Clause 24: The method of Clause 20, wherein the same measurement object is used for configuring measurement objects for both RRM prediction and performance monitoring.

Clause 25: The method of Clause 24, wherein the same measurement object is configured for reporting the first result based on a first report configuration identifier for the RRM prediction and for reporting a measurement result based on a second report configuration identifier for the performance monitoring.

Clause 26: The method of Clause 20, wherein the indication of the first measurement object comprises the first report, wherein the first report is sent with the second report.

Clause 27: The method of any one of Clauses 19-26, wherein the first measurement object is different than the second measurement object.

Clause 28: The method of Clause 27, wherein the indication of the first measurement object is a measurement identity that indicates the first measurement object.

Clause 29: The method of Clause 27, wherein the one or more measurement object indications include a first measurement object indication that indicates the first measurement object and a second measurement object indication that indicates the second measurement object.

Clause 30: The method of Clause 29, wherein the second measurement object indication further indicates a first report configuration for the first report and a second report configuration for the second report.

Clause 31: The method of Clause 27, wherein the first report and the second report are included in a single report.

Clause 32: The method of Clause 31, wherein the single report includes a first indication of the first measurement object or a second indication of the second measurement object.

Clause 33: The method of Clause 31, wherein the single report includes a first portion for the first result and a second portion for the second result.

Clause 34: The method of any one of Clauses 19-33, wherein receiving the second report comprises receiving the second report at each of a set of configured monitoring occasions.

Clause 35: The method of any one of Clauses 19-34, wherein receiving the second report comprises receiving the second report based on a monitoring window, wherein the second result is based on a set of monitoring occasions in the monitoring window.

Clause 36: One or more apparatuses, comprising: one or more memories comprising executable instructions; and one or more processors configured to execute the executable instructions and cause the one or more apparatuses to perform a method in accordance with any one of Clauses 1-35.

Clause 37: One or more apparatuses configured for wireless communications, comprising: one or more memories; and one or more processors, coupled to the one or more memories, configured to cause the one or more apparatuses to perform a method in accordance with any one of Clauses 1-35.

Clause 38: One or more apparatuses configured for wireless communications, comprising: one or more memories; and one or more processors, coupled to the one or more memories, configured to perform a method in accordance with any one of Clauses 1-35.

Clause 39: One or more apparatuses, comprising means for performing a method in accordance with any one of Clauses 1-35.

Clause 40: One or more non-transitory computer-readable media comprising executable instructions that, when executed by one or more processors of one or more apparatuses, cause the one or more apparatuses to perform a method in accordance with any one of Clauses 1-35.

Clause 41: One or more computer program products embodied on one or more computer-readable storage media comprising code for performing a method in accordance with any one of Clauses 1-35.

Clause 42: One or more apparatuses configured for wireless communications, comprising: a processing system that includes one or more processors and one or more memories coupled with the one or more processors, the processing system configured to cause the one or more apparatuses to perform a method in accordance with any one of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause the apparatus to:
receive a measurement configuration comprising one or more measurement object indications, the one or more measurement object indications indicating a first measurement object associated with radio resource management (RRM) prediction and a second measurement object associated with performance monitoring for the RRM prediction;
transmit a first report, based on the first measurement object, of a first result of the RRM prediction; and
transmit a second report, based on the second measurement object, of a second result of the performance monitoring, wherein the second report includes or is associated with an indication of the first measurement object associated with the RRM prediction.

2. The apparatus of claim 1, wherein the first measurement object and the second measurement object are a same measurement object.

3. The apparatus of claim 2, wherein the first report is based on a first reporting configuration containing a report configuration identifier for the RRM prediction and the second report is based on a second reporting configuration containing a report configuration identifier for the performance monitoring.

4. The apparatus of claim 2, wherein the indication of the first measurement object is a measurement identity that indicates the first measurement object.

5. The apparatus of claim 4, wherein the measurement identity further indicates a report configuration identifier for the RRM prediction.

6. The apparatus of claim 2, wherein the same measurement object is used for configuring measurement objects for both RRM prediction and performance monitoring.

7. The apparatus of claim 6, wherein the same measurement object is configured for reporting the first result based on a first report configuration identifier for the RRM prediction and for reporting a measurement result based on a second report configuration identifier for the performance monitoring.

8. The apparatus of claim 2, wherein the indication of the first measurement object comprises the first report, wherein the first report is sent with the second report.

9. The apparatus of claim 1, wherein the first measurement object is different than the second measurement object.

10. The apparatus of claim 9, wherein the indication of the first measurement object is a measurement identity that indicates the first measurement object.

11. The apparatus of claim 9, wherein the one or more measurement object indications include a first measurement object indication that indicates the first measurement object and a second measurement object indication that indicates the second measurement object.

12. The apparatus of claim 11, wherein the second measurement object indication further indicates a first report configuration for the first report and a second report configuration for the second report.

13. The apparatus of claim 9, wherein the first report and the second report are included in a single report.

14. The apparatus of claim 13, wherein the single report includes a first indication of the first measurement object or a second indication of the second measurement object.

15. The apparatus of claim 13, wherein the single report includes a first portion for the first result and a second portion for the second result.

16. The apparatus of claim 1, wherein to cause the apparatus to transmit the second report, the processing system is configured to cause the apparatus to transmit the second report at each of a set of configured monitoring occasions.

17. The apparatus of claim 1, wherein to cause the apparatus to transmit the second report, the processing system is configured to cause the apparatus to transmit the second report based on a monitoring window, wherein the second result is based on a set of monitoring occasions in the monitoring window.

18. The apparatus of claim 17, wherein the processing system is configured to cause the apparatus to combine a set of indicators that are based on measurements in the set of monitoring occasions to generate the second result.

19. An apparatus comprising a processing system that includes one or more processors and one or more memories coupled with the one or more processors, the processing system configured to cause the apparatus to:
transmit a measurement configuration comprising one or more measurement object indications, the one or more measurement object indications indicating a first measurement object associated with radio resource management (RRM) prediction and a second measurement object associated with performance monitoring for the RRM prediction;
receive a first report, based on the first measurement object, of a first result of the RRM prediction; and
receive a second report, based on the second measurement object, of a second result of the performance monitoring, wherein the second report includes or is associated with an indication of the first measurement object associated with the RRM prediction.

20. A method of wireless communication by an apparatus, comprising:
receiving a measurement configuration comprising one or more measurement object indications, the one or more measurement object indications indicating a first measurement object associated with radio resource management (RRM) prediction and a second measurement object associated with performance monitoring for the RRM prediction;
transmitting a first report, based on the first measurement object, of a first result of the RRM prediction; and
transmitting a second report, based on the second measurement object, of a second result of the performance monitoring, wherein the second report includes or is associated with an indication of the first measurement object associated with the RRM prediction.
